(19) United States
(12) Patent Application Publication
(10) Pub. No.: US 2015/0294783 A1
(43) Pub. Date: Oct. 15, 2015

(54) NOISE FILTER AND WIRE HARNESS ASSEMBLY INCLUDING THE SAME

(71) Applicant: Yazaki Corporation, Tokyo (JP)

(72) Inventors: Shouichi Furukawa, Susono-shi (JP); Koji Miyawaki, Susono-shi (JP)

(21) Appl. No.: 14/679,257

(22) Filed: Apr. 6, 2015

(30) Foreign Application Priority Data
Apr. 14, 2014 (JP) 2014-083118

(51) Int. Cl. H01F 27/34

(52) U.S. Cl. CPC H01F 27/34

(57) ABSTRACT

A noise filter that can be downsized without losing sufficient de-noising performance is provided. A noise filter includes an input terminal and an output terminal both configured to be coupled to a wire harness, a pair of inductors and provided on an electrically-conducting path from the input terminal to the output terminal, a first bus bar, a second bus bar, a third bus bar, a capacitor, and a ground bus bar configured to be coupled to the ground. The first bus bar, the second bus bar, and the third bus bar constitute the electrically-conducting path from the input terminal to the output terminal. In the noise filter, the ground bus bar is positioned between the first bus bar and the second bus bar both located between the inductors and, where capacitive coupling is likely to occur.

### TECHNICAL FIELD

The present invention relates to a noise filter coupled to a wire harness mounted on an automobile or the like, and a wire harness assembly including the noise filter.

### BACKGROUND ART

Conventionally, a noise filter coupled to a wire harness to remove electrical noise in the wire harness is known (for example, refer to Patent Literature 1). The noise filter takes various configurations including, for example, a noise filter configured with a resin housing containing a terminal coupled to the wire harness, a plurality of coils, a capacitor, and circuit members for coupling these parts.

### CITATION LIST

### Patent Literature

Patent Literature 1: JP 2009-111832 A

### SUMMARY OF INVENTION

### Technical Problem

In the above-described noise filters, further downsizing is desired. However, it seems unattainable to further downsize noise filters without losing sufficient de-noising performance. One reason is that if the gap between parts, such as circuit elements and circuit members, are simply downsized, noise propagation due to capacitive coupling is more likely to occur between the parts, resulting in the noise deviating from a circuit through which a noise is to flow in the noise filter.

The likelihood of occurrence of noise propagation due to capacitive coupling depends not only on the gap between parts. For example, the capacitive coupling tends to take place particularly in a vicinity of an inductance generator, such as coils, so that a large gap should be provided between the parts located near the inductance generator. For this reason, it is very difficult to downsize a noise filter including a plurality of inductance generators without losing sufficient de-noising performance.

Accordingly, an object of the present invention is to provide a noise filter that can be downsized without losing sufficient de-noising performance, and a wire harness assembly including the noise filter.

### Solution to Problem

To achieve the object, the invention according to a first aspect is a noise filter configured to be coupled to a wire harness and including: an input portion and an output portion both configured to be coupled to the wire harness; a pair of inductance generators provided on an electrically-conducting path from the input portion and the output portion; and a metal member configured to be coupled to the ground, wherein the metal member is at least positioned between a location of one of the inductance generators and a location of the other one of the inductance generators.

In the invention according to the first aspect, the invention according to a second aspect includes the metal member being positioned between a location of the input portion and a location of the output portion.

In the invention according to the first or the second aspect, the invention according to a third aspect includes the input portion, the output portion, a circuit member constituting the electrically-conducting path from the input portion to the output portion, and the metal member are configured with a plurality of bus bars formed of metal plates, and that the plurality of bus bars, the pair of inductance generators, a capacitor being contained in a housing to form a unit.

The invention according to a forth aspect is a wire harness assembly including the noise filter according to the preceding aspects and a wire harness coupled to the noise filter.

In the invention according to the forth aspect, the invention according to a fifth aspect includes the wire harness including a first conductive wire coupled to the input portion, a second conductive wire coupled to the output portion, and a third conductive wire positioned between the first conductive wire and the second conductive wire, where a portion of the third conductive wire that is remote from the noise filter is opened and the metal member is coupled to the third conductive wire.

### Advantageous Effects of Invention

According to the invention according to the first, the second and the forth aspect, the metal member is at least positioned between a location of one of the inductance generators and a location of the other one of the inductance generators, so that capacitive coupling may cause a noise to propagate from the vicinity of either of the inductance generators to the metal member but may not cause a noise to propagate from one of the inductance generators to the other one of the inductance generators. Thus, the gap between parts near the pair of inductance generators can be reduced, thereby achieving downsizing of the noise filter without losing sufficient de-noising performance.

According to the invention according to the second aspect, the metal member is positioned between a location of the input portion and a location of the output portion, so that a noise propagation from the input portion to the output portion due to capacitive coupling is not likely to occur.

According to the invention according to the fifth aspect, the wire harness includes the first conductive wire coupled to the input portion, the second conductive wire coupled to the output portion, and the third conductive wire positioned between the first conductive wire and the second conductive wire, where a portion of the third conductive wire that is remote from the noise filter is opened and the metal member is coupled to the third conductive wire. Accordingly, a noise propagation between the first conductive wire and the second conductive wire due to capacitive coupling is not likely to occur, and a noise is led to the ground via the third conductive wire and the metal member coupled to the third conductive wire.

### BRIEF DESCRIPTION OF DRAWINGS

FIG. 1 is a perspective view of a noise filter according to a first embodiment of the present invention.

FIG. 2 is a perspective view of a plurality of bus bars and a bracket constituting the noise filter illustrated in FIG. 1.

FIG. 3 is an explanatory drawing illustrating a configuration of the noise filter illustrated in FIG. 1.

FIG. 4 is an explanatory drawing illustrating a configuration of a wire harness coupled to the noise filter illustrated in FIG. 1.

FIG. 5 is a circuit diagram of a de-noising circuit of a wire harness using the noise filter illustrated in FIG. 1.

FIG. 6 is an explanatory drawing illustrating a configuration of a noise filter according to a second embodiment of the present invention.

FIG. 7 is an explanatory drawing illustrating a configuration of the wire harness coupled to the noise filter illustrated in FIG. 6.

FIG. 8 is a circuit diagram of a de-noising circuit of a wire harness that uses the noise filter illustrated in FIG. 6.

### DESCRIPTION OF EMBODIMENTS

### First Embodiment

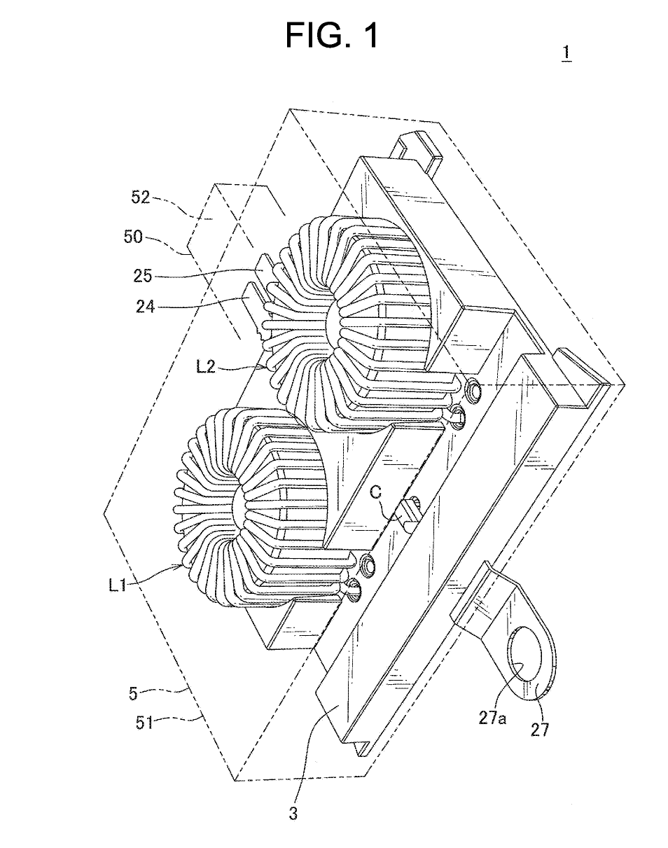

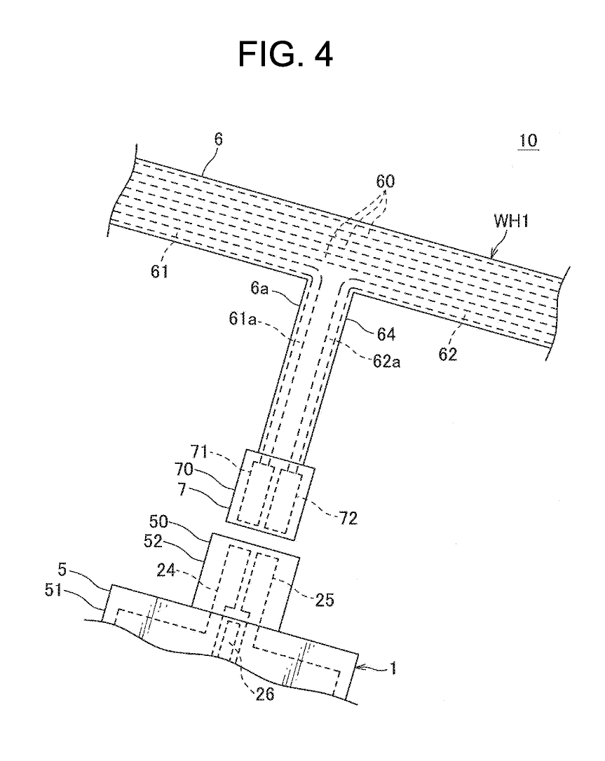

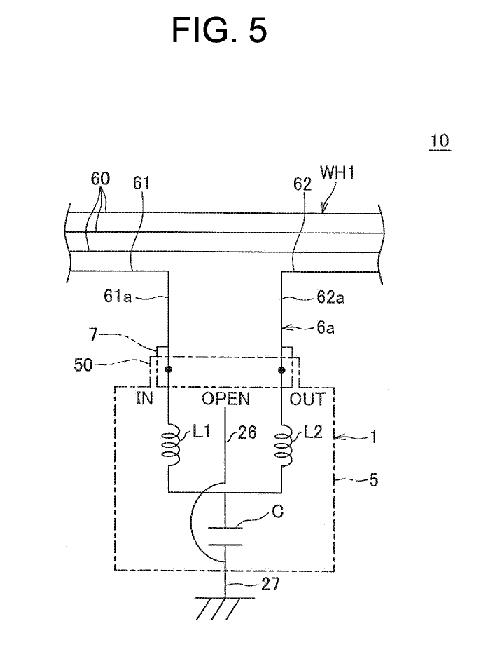

A “noise filter” and a “wire harness assembly” according to a first embodiment of the present invention are described referring to FIGS. 1 to 5. A noise filter 1 illustrated in FIG. 1 is coupled to a wire harness WH1 illustrated in FIG. 4 to constitute a de-noising circuit 10 of the wire harness WH1 illustrated in FIG. 5. The de-noising circuit 10 is configured with a branched line 6a branched from a main cable 6 of the wire harness WH1 and a noise filter 1 coupled to a distal end of the branched line 6a. The “wire harness assembly” includes the noise filter 1 and the wire harness WH1 coupled to the noise filter 1.

The wire harness WH1 is arranged in a vehicle to couple together parts mounted on the vehicle. As illustrated in FIG. 4, the wire harness WH1 includes the main cable 6 that is a plurality of bundled electric wires 60, 61, and 62, and a branched line 6a. The branched line 6a includes branched electric wires 61a and 62a which are portions of the electric wires 61 and 62, respectively, branching off from the main cable 6, female terminals 71 and 72 attached to distal ends of the branched electric wires 61a and 62a, and a connector housing 70 containing the terminals 71 and 72. Among the electric wires 60, 61, and 62 of the main cable 6, the electric wires 61 and 62 are to be de-noised. The terminals 71 and 72 and the connector housing 70 constitute a connector 7. A pair of branched electric wires 61a and 62a extends in parallel to each other and is wrapped around by a tape 64.

As illustrated in FIGS. 1 to 3, the noise filter 1 includes a male input terminal (corresponding to “input portion” in claims) 24 coupled to the branched electric wire 61a, a male output terminal (corresponding to “output portion” in claims) 25 coupled to the branched electric wire 62a, a pair of inductors (corresponding to “inductance generators” in claims) L1 and L2 provided on the electrically-conducting path from the input terminal 24 to the output terminal 25, a first bus bar 21, a second bus bar 22, a third bus bar 23, a ground bus bar (corresponding to “metal member” in claims) 26, a capacitor C, a bracket 27, an attachment member 3, and a housing 5. The first bus bar 21, the second bus bar 22, and the third bus bar 23 serve as “circuit members” constituting the electrically-conducting path from the input terminal 24 to the output terminal 25.

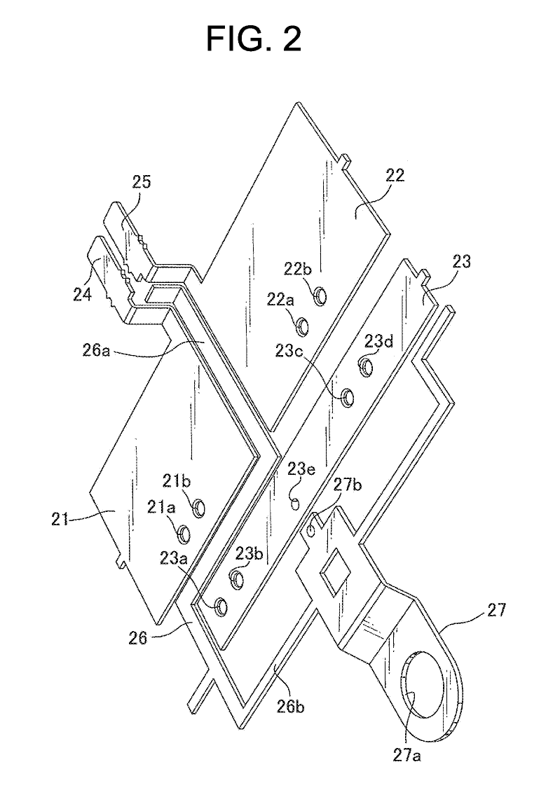

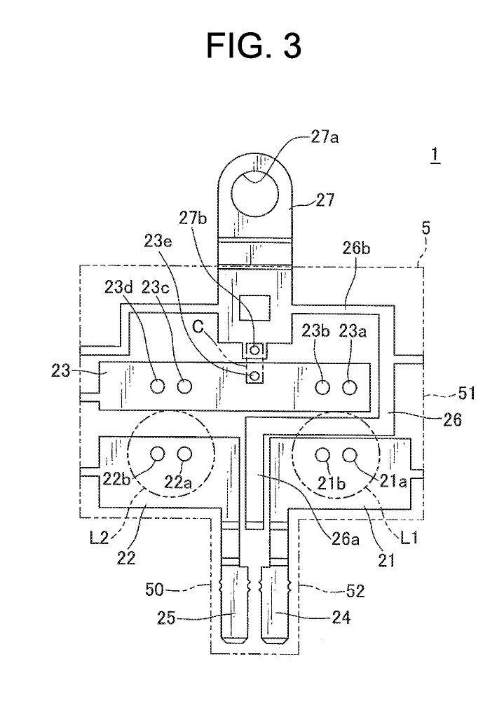

The input terminal 24, the output terminal 25, the first bus bar 21, the second bus bar 22, the third bus bar 23, the ground bus bar 26, and the bracket 27 are configured in a form illustrated in FIGS. 2 and 3, by integrating base materials, cut out from a single metal sheet, with a resin-made attachment member 3 by insert forming, and by cutting off unnecessary portions from the base materials.

The input terminal 24 and the output terminal 25 are formed in elongate plates and are separately disposed in parallel with each other. The input terminal 24 and the output terminal 25 are positioned in a below-described connecting sleeve 52 of the housing 5, which together constitute a connector 50. The connector 50 is coupled to a connector 7 of the branched line 6a. When coupling the connector 50 and the connector 7, the input terminal 24 couples with the terminal 71 attached to the distal end of the branched electric wire 61a, and the output terminal 25 couples with the terminal 72 attached to the distal end of the branched electric wire 62a.

The first bus bar 21 and the second bus bar 22 are formed in rectangular shapes in a plan view and are separately disposed so as the short sides thereof to be in parallel to each other. That is, the first bus bar 21 and the second bus bar 22 are disposed so as the long sides thereof to be in line. The input terminal 24 is integrally formed with the first bus bar 21 to extend therefrom in the direction along the short side of the first bus bar 21. The output terminal 25 is integrally formed with the second bus bar 22 to extend therefrom in the direction along the short side of the second bus bar 22. The third bus bar 23 is formed in an elongate rectangular shape and is disposed so as the long side thereof to be parallel to the long sides of the first bus bar 21 and the second bus bar 22. A gap exists between the third bus bar 23 and the first bus bar 21 and between the third bus bar 23 and the second bus bar 22.

The bracket 27 is disposed by the side of the third bus bar 23 remote from the first bus bar 21 and the second bus bar 22. A bolt through hole 27a is provided in an end of the bracket 27. The bracket 27 is grounded (body earthed) when secured on a vehicle panel with a bolt inserter through the bolt through hole 27a.

The ground bus bar 26 is integrally formed with the bracket 27 to extend therefrom so as to bypass the third bus bar 23 and to reach the region near the input terminal 24 and the output terminal 25. The ground bus bar 26 includes a portion 26b connected to the bracket 27 and a portion 26a disposed between the first bus bar 21 and the second bus bar 22. The rest of the ground bus bar 26 other than the portion 26b connected to the bracket 27 is opened, and has no electric connection. The portion 26a is disposed between, and in the same plane of, the short side of the first bus bar 21 and the short side of the second bus bar 22.

Toroidal coils, in which wires are wound around toroidal cores, are used as the pair of inductors L1 and L2 in the embodiment. For the inductor L1, one of lead wires is inserted in a through hole 21a or a through hole 21b of the first bus bar 21 and secured with solder, and the other one of the lead wires is inserted in a through hole 23a or a through hole 23b of the third bus bar 23 and secured with solder. For the inductor L2, one of lead wires is inserted in the through hole 22a or the through hole 22b of the second bus bar 22 and secured with solder, and the other one of the lead wires is inserted in a through hole 23c or a through hole 23d of the third bus bar 23 and secured with solder. As illustrated in FIG. 3, the portion 26a of the ground bus bar 26 is positioned between the location of the inductor L1 and the location of the inductor L2.

For the capacitor C, one of lead wires is inserted in the through hole 23e of the third bus bar 23 and secured with solder, and the other one of the lead wires is inserted in a through hole 27b of the bracket 27 and secured with solder.

The housing 5 is composed of a synthetic resin and includes a connecting sleeve 52 for positioning the input terminal 24 and the output terminal 25 and a main body 51 containing the rest of parts. The bolt through hole 27a of the bracket 27 is positioned outside the housing 5. In this manner, the input terminal 24, the output terminal 25, the first bus bar 21, the second bus bar 22, the third bus bar 23, the ground bus bar 26, the bracket 27, the attachment member 3, the pair of inductors L1 and L2, and the capacitor C are contained in the housing 5, and the noise filter 1 is provided as a unit.

The noise filter 1 thus configured removes noise (high frequency noise) in a current input from the branched electric wire 61a, and outputs a resulting current without noise to the branched electric wire 62a.

In general, as described above, noise propagation due to capacitive coupling is likely to occur particularly in a vicinity of an inductance generator, such as coils. However, for this noise filter 1, noise propagation due to capacitive coupling is not likely to occur between the first bus bar 21 and the second bus bar 22, because the portion 26a of the ground bus bar 26 is positioned between the first bus bar 21 and the second bus bar 22 both located between the inductors L1 and L2, where capacitive coupling is likely to occur. Specifically, a noise that deviates from the circuit through which a noise is to flow and might propagate from the first bus bar 21 directly to the second bus bar 22 is led to the ground via the ground bus bar 26 which is disposed in a location closer to the first bus bar 21 than the second bus bar 22. Consequently, the noise propagation due to capacitive coupling is not likely to occur between the first bus bar 21 and the second bus bar 22. Thus, the gap between the first bus bar 21 and the second bus bar 22 provided between the inductors L1 and L2, where capacitive coupling is likely to occur, can be reduced. Accordingly, the noise filter 1 can be downsized without losing sufficient de-noising performance.

### Second Embodiment

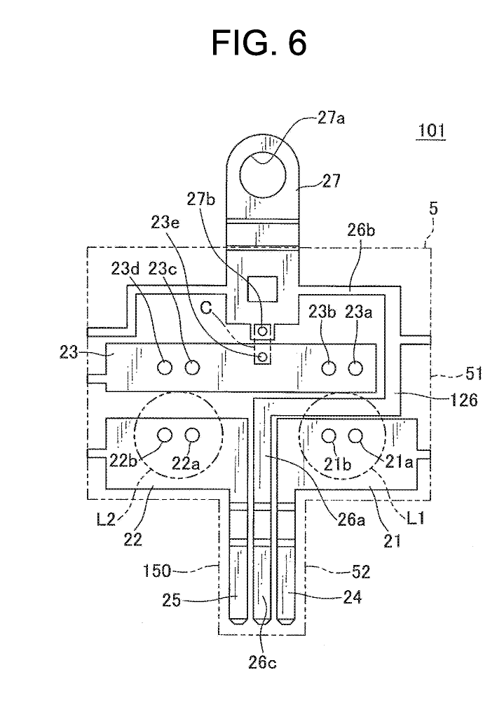

“Noise filter” and “wire harness assembly” according to a second embodiment of the present invention will be described referring to FIGS. 6 to 8. In FIGS. 6 to 8, the same component as that in the first embodiment is appended with the same reference sign and the description thereof is omitted.

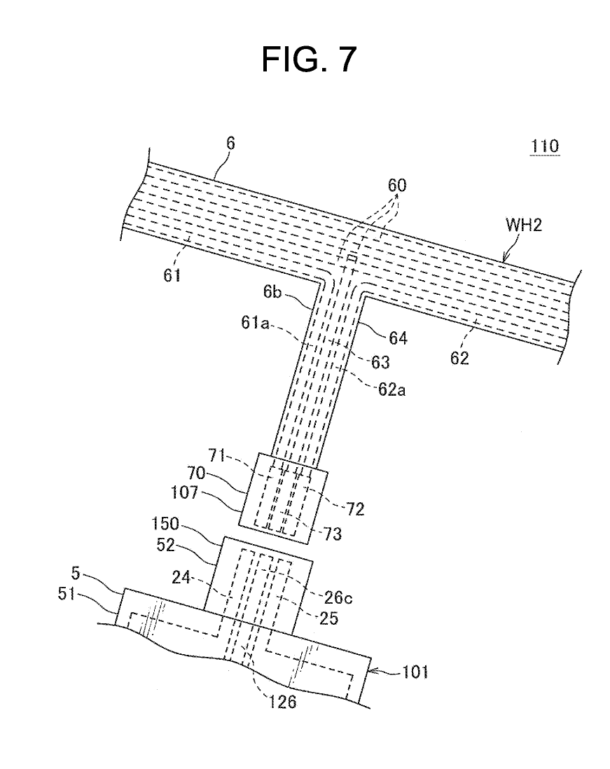

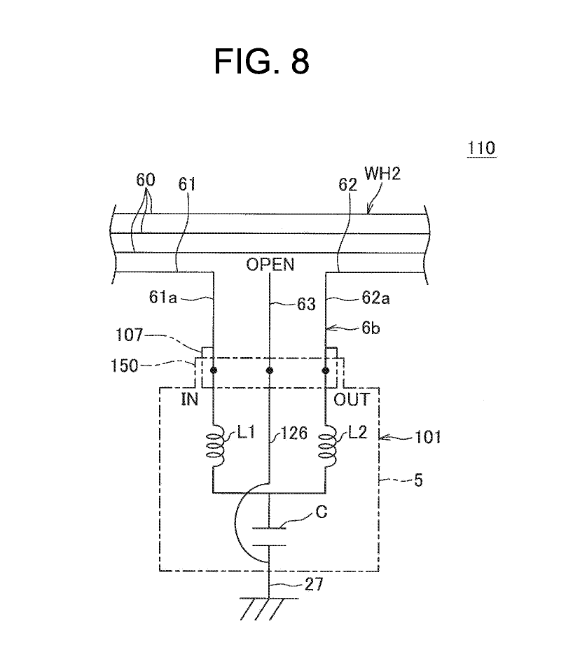

A noise filter 101 illustrated in FIG. 6 is coupled to a wire harness WH2 illustrated in FIG. 7 to constitute a de-noising circuit 110 of the wire harness WH2 illustrated in FIG. 8. The de-noising circuit 110 is configured with a branched line 6b branched from a main cable 6 of the wire harness WH2 and a noise filter 101 coupled to a distal end of the branched line 6b. The “wire harness assembly” includes the noise filter 101 and the wire harness WH2 coupled to the noise filter 101.

As illustrated in FIG. 7, the branched line 6b of the wire harness WH2 includes branched electric wires 61a and 62a branched from the main cable 6, a ground wire 63 positioned between the branched electric wires 61a and 62a and has an opened end in the side remote from the noise filter 101 (the side in the main cable 6), female terminals 71 and 72 attached to distal ends of the branched electric wires 61a and 62a, a female terminal 73 attached to a distal end of the ground wire 63, and a connector housing 70 containing the terminals 71, 72, and 73. The terminals 71, 72, and 73 constitute a connector 107 of the connector housing 70.

The ground wire 63 extends between and parallel to the pair of branched electric wires 61a and 62a. An end of the ground wire 63 remote from the noise filter 101 is positioned in the vicinity of the radial center of the main cable 6 and has no electric coupling. The branched electric wires 61a and 62a and the ground wire 63 are wrapped around with a tape 64 so that the positional relationship of these electric wires can be kept (keep the ground wire 63 in the center).

With the ground wire 63 positioned between the pair of branched electric wires 61a and 62a, the noise propagation due to the line capacity between the branched electric wire 61a and the branched electric wire 62a is likely not to occur even when the branched electric wires 61a and 62a are proximal to each other. Specifically, a noise that deviates from the noise filter 101 and might propagate from the branched electric wire 61a directly to the branched electric wire 62a is led to the ground via the ground wire 63 disposed in a location closer to the branched electric wire 61a than the branched electric wire 62a. Therefore, the noise propagation is likely not to occur between the branched electric wire 61a and the branched electric wire 62a.

The branched electric wire 61a corresponds to “first conductive wire” in claims. The branched electric wire 62a corresponds to “second conductive wire” in claims. The branched ground wire 63 corresponds to “third conductive wire” in claims.

The noise filter 101 includes a ground bus bar 126 instead of the ground bus bar 26 described in the first embodiment. The ground bus bar 126 includes a male terminal 26c extending from the portion 26a disposed between the first bus bar 21 and the second bus bar 22. The terminal 26c is positioned between the location of the input terminal 24 and the location of the output terminal 25 inside the connecting sleeve 52 of the housing 5 to constitute a connector 150. The connector 150 and the connector 107 of the branched line 6b are coupled. When the connector 150 and the connector 107 are coupled, the terminal 26c provided on the ground bus bar 126 is coupled to the terminal 73 attached to a distal end of the ground wire 63.

In the noise filter 101 configured as described above, noise propagation due to capacitive coupling between the input terminal 24 and the output terminal 25 is likely not to occur because the ground bus bar 126 is positioned between the location of the input terminal 24 and the location of the output terminal 25. Furthermore, since the terminal 26c provided on the ground bus bar 126 is coupled to the ground wire 63 via the terminal 73, the noise in the ground wire 63 can be grounded via the ground bus bar 126.

The embodiment described above is merely an illustrative representation of the present invention, and should not be construed to limit the scope of the present invention. Various modifications may be made without departing from the scope of the present invention.

### REFERENCE SIGNS LIST

1, 101 noise filter
24 input terminal (input portion)
25 output terminal (output portion)
26, 126 ground bus bar (metal member)
L1, L2 inductor (inductance generator)
WH1, WH2 wire harness

1. A noise filter configured to be coupled to a wire harness, comprising:
an input portion and an output portion both configured to be coupled to the wire harness;
a pair of inductance generators provided on an electrically-conducting path from the input portion to the output portion; and
a metal member configured to be coupled to ground, wherein
the metal member is at least positioned between a location of one of the inductance generators and a location of the other one of the inductance generators.

2. The noise filter according to claim 1, wherein
the metal member is positioned between a location of the input portion and a location of the output portion.

3. The noise filter according to claim 1, wherein
the input portion, the output portion, a circuit member constituting the electrically-conducting path from the input portion to the output portion, and the metal member are made of a plurality of bus bars made of metal plates, and
the plurality of bus bars, the pair of inductance generators, and a capacitor are contained in a housing to form a unit.

4. The noise filter according to claim 2, wherein
the input portion, the output portion, a circuit member constituting the electrically-conducting path from the input portion to the output portion, and the metal member are made of a plurality of bus bars made of metal plates, and
the plurality of bus bars, the pair of inductance generators, and a capacitor are contained in a housing to form a unit.

5. A wire harness assembly comprising:
the noise filter according to claim 1; and
a wire harness coupled to the noise filter.

6. A wire harness assembly comprising:
the noise filter according to claim 2; and
a wire harness coupled to the noise filter.

7. A wire harness assembly comprising:
the noise filter according to claim 3; and
a wire harness coupled to the noise filter.

8. A wire harness assembly comprising:
the noise filter according to claim 4; and
a wire harness coupled to the noise filter.

9. The wire harness assembly according to claim 5, wherein
the wire harness includes a first conductive wire coupled to the input portion, a second conductive wire coupled to the output portion, and a third conductive wire positioned between the first conductive wire and the second conductive wire, a portion of the third conductive wire remote from the noise filter being opened, and
the metal member is coupled to the third conductive wire.

10. The wire harness assembly according to claim 6, wherein
the wire harness includes a first conductive wire coupled to the input portion, a second conductive wire coupled to the output portion, and a third conductive wire positioned between the first conductive wire and the second conductive wire, a portion of the third conductive wire remote from the noise filter being opened, and
the metal member is coupled to the third conductive wire.

11. The wire harness assembly according to claim 7, wherein
the wire harness includes a first conductive wire coupled to the input portion, a second conductive wire coupled to the output portion, and a third conductive wire positioned between the first conductive wire and the second conductive wire, a portion of the third conductive wire remote from the noise filter being opened, and
the metal member is coupled to the third conductive wire.

12. The wire harness assembly according to claim 8, wherein
the wire harness includes a first conductive wire coupled to the input portion, a second conductive wire coupled to the output portion, and a third conductive wire positioned between the first conductive wire and the second conductive wire, a portion of the third conductive wire remote from the noise filter being opened, and
the metal member is coupled to the third conductive wire.
